(19) United States
(12) Patent Application Publication
(10) Pub. No.: US 2005/0207275 A1
(43) Pub. Date: Sep. 22, 2005

(54) Mixing and stirring devices

(76) Inventor: David Lee Luedtke, Los Altos, CA (US)

Correspondence Address: Robert Moll, 1173 St. Charles Court, Los Altos, CA, 94024, US

(21) Appl. No.: 10/804,753

(22) Filed: Mar. 19, 2004

(51) Int. Cl. B01F 13/00

(52) U.S. Cl. 366/343

(57) ABSTRACT

The present invention relates to a mixing and stirring device suitable for stirring food. In an embodiment, the mixing and stirring device includes a shaft with a locking jig to fit into a kitchen appliance electric mixer and a substantially cylindrical shaped auger stirring head extending laterally from the shaft, wherein the auger stirring head includes twisted surfaces cut on anti-parallel surfaces forming a set of blade edges. The auger stirring head also has concave surfaces to generate uplift movements and blade edges to drill and cut solid content food without causing spillage. The cross-section of the shaft may be rectangular, triangular and circular. The mixing and stirring device may be coated for protection from scratches, corrosion, and for easy cleaning. In another embodiment, the stirring head is a tear drop shape. In yet another embodiment, the mixing and stirring device is a disposable hand stirring and mixing device.

### BACKGROUND

The present invention relates to a mixing and stirring device adapted for a kitchen appliance electric mixer or hand stirring of foods.

Foods such as natural peanut butter are sold without the use of hydrogenated oils and the sales are increasing due to health benefits. Natural peanut butter contains oil that naturally separates once settled and requires stirring before each use. The use of an ordinary butter knife can cause wrist stress and spillage during stirring.

Egg beater attachments for kitchen appliance electric mixers are designed for low viscosity food mixtures such as eggs, flour mix, or cream. They are not designed to break up food mixtures with high solid content, and a time consuming cleaning process follows after such use. To avoid spillage while stirring, the food container is usually large or the mixer speed must be reduced. It would be desirable if a stirring and mixing device existed that could overcome these problems.

### SUMMARY OF THE INVENTION

The present invention relates to a mixing and stirring device suitable for stirring foods. In an aspect of the invention, the mixing and stirring device includes a shaft with a locking jig to fit into a kitchen appliance electric mixer and a substantially cylindrical shaped auger stirring head extending laterally from the shaft, wherein the auger stirring head includes twisted surfaces cut on anti-parallel surfaces forming a set of blade edges. The auger stirring head has concave surfaces to generate uplifting movements and blade edges to drill and cut solid content food without causing spillage. The cross-section of the hollow or solid shaft may be rectangular, triangular and circular. The mixing and stirring device may be coated for protection from scratches, corrosion and for easy cleaning. In another aspect, the stirring head is a tear drop shape. In yet another aspect, the mixing and stirring device is a hand mixing and stirring device.

### BRIEF DESCRIPTION OF THE DRAWINGS

FIG. 1A is a perspective view of an embodiment of the mixing and stirring device with a rectangular shaft and an auger stirring head.

FIG. 1B is a section view of the rectangular shaft and the auger stirring head.

FIG. 2A is a perspective view of another embodiment of the mixing and stirring device with a triangular shaft and an auger stirring head.

FIG. 2B is a section view of the triangular shaft and the auger stirring head.

FIG. 3A is a perspective view of another embodiment of the mixing and stirring device with a rectangular shaft and a tear drop stirring head.

FIG. 3B is a perspective view of another embodiment of the mixing and stirring device with a cylindrical shaft and the tear drop stirring head.

FIG. 3C is a perspective view of another embodiment of the mixing and stirring device with a cylindrical shaft and an auger stirring head.

FIG. 4 illustrates the use of the mixing and stirring device with a kitchen appliance electric mixer stirring a high viscosity food.

FIG. 5A illustrates embodiments of the hand mixing and stirring devices.

FIG. 5B illustrates the use of the hand mixing and stirring devices.

### DETAILED DESCRIPTION OF THE PREFERRED EMBODIMENTS

The following description includes the best mode of the invention. The detailed description is made to illustrate the general principles of the invention and should not be taken in a limiting sense. The scope of the invention is determined by reference to the claims. Each part, even if structurally identical to another part, is assigned its own part number to distinguish where the part appears in the drawings.

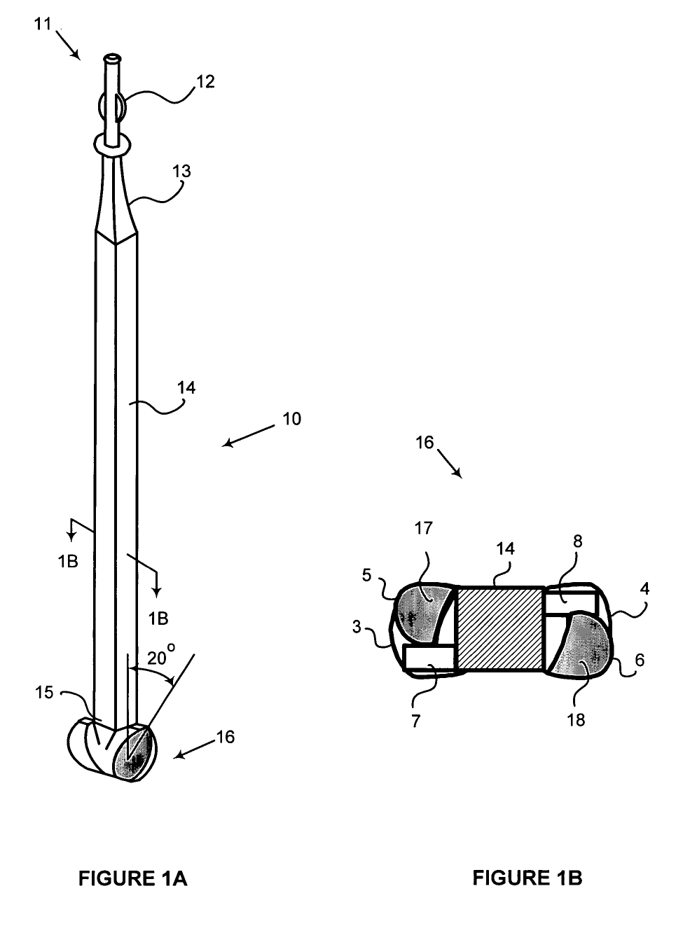

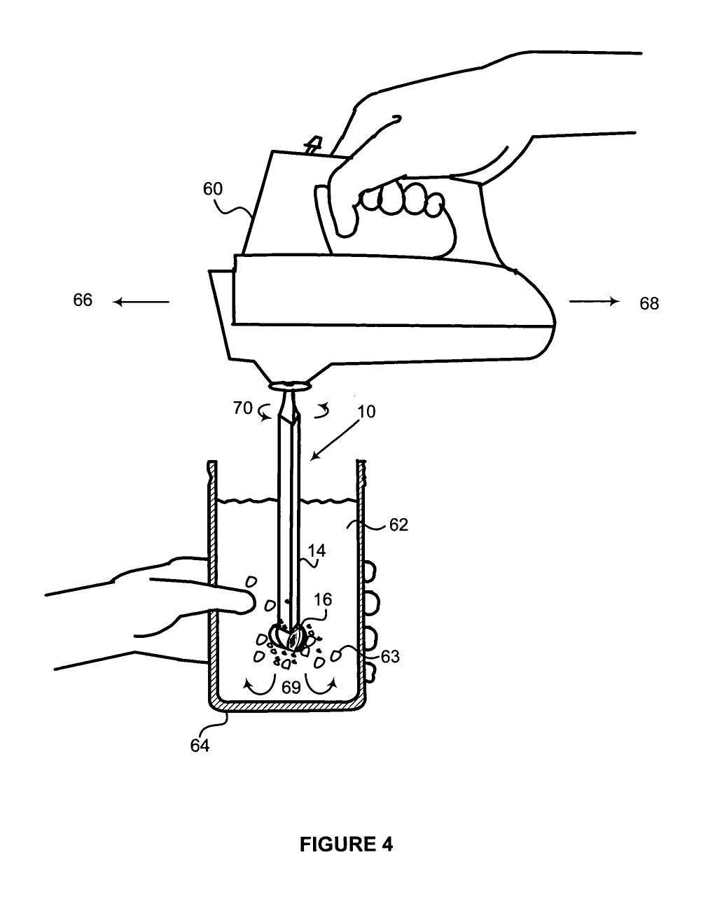

FIG. 1A is a perspective view of an embodiment of the mixing and stirring device 10 suitable for use with a kitchen appliance electric mixer. In this embodiment, the mixing and stirring device 10 includes a rigid shaft 14 having a first end 11 that preferably includes a tapered neck 13 that extends to a locking jig 12 and a second end 15 that supports an auger stirring head 16. The locking jig 12 fits into the receptacle of a known kitchen appliance electric mixer such as shown in FIG. 4. The mixing and stirring device 10 is made of a rigid material such as stainless steel, a metal alloy, or a rigid plastic or ceramic material. Powder paint, ceramic coating, or a chemical surface treatment can coat the mixing and stirring device 10 to protect its surfaces against scratches and corrosion and ensure safety in a food environment.

FIG. 1B is a sectional view of a solid rectangular shaft 14 with an auger stirring head 16. The auger stirring head 16 is substantially cylindrical shaped and extends laterally from the shaft 14. The lateral extensions 3 and 4 have blade edges 5 and 6 and twisted concave surfaces 17 and 18 that are anti-parallel to each other and have an angular rotation of about 20 degrees (FIG. 1A) from the axis of the shaft 14. During rotation of the shaft 14 the twisted concave surfaces 17 and 18 generate an uplifting movement while the blade edges 5 and 6 cut any solids. The shoulders 7 and 8 stiffen the blade edges 5 and 6.

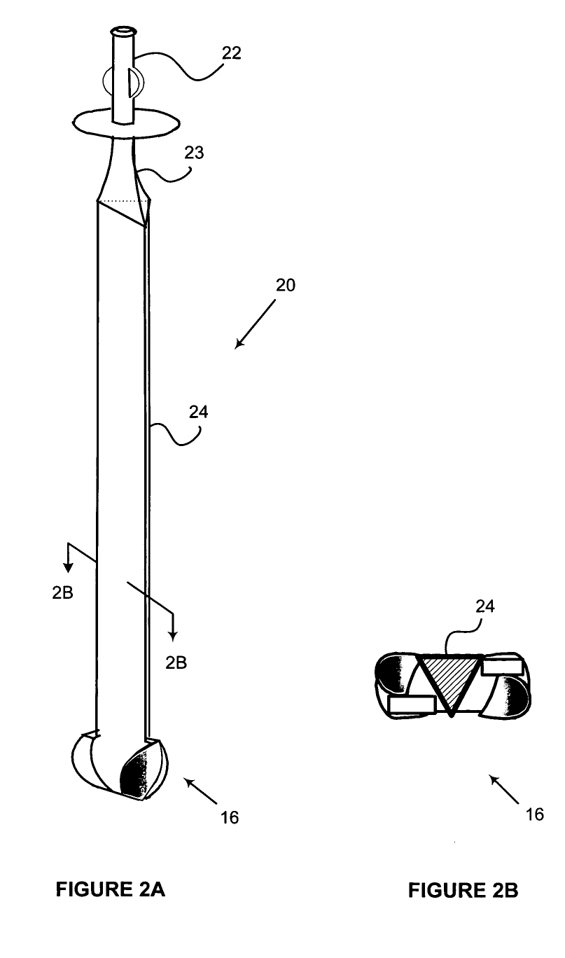

FIG. 2A is a perspective view of another embodiment of a mixing and stirring device 20 having a triangular shaft 24 with a tapered neck 23 with a locking jig 22 and the auger stirring head 16 shown in FIGS. 1A-1B. FIG. 2B is a sectional view of the solid triangular shaft 24 with the auger stirring head 16.

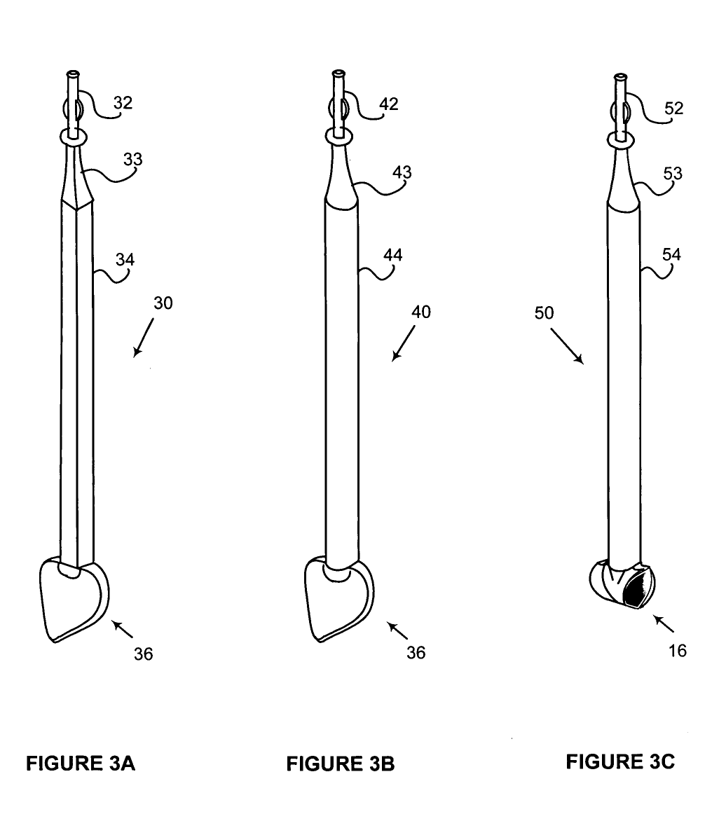

FIGS. 3A-3C are perspective views of mixing and stirring devices 30, 40 and 50 with different shafts and stirring heads. Referring to FIG. 3A, the mixing and stirring device 30 has a rectangular cross-sectional shaft 34 and a tear drop shaped stirring head 36. Referring to FIG. 3B, the mixing and stirring device 40 has a circular cross-sectional shaft 44 with the tear drop stirring head 36. Referring to FIG. 3C, the mixing and stirring device 50 has a circular cross-sectional shaft 54 and an auger stirring head 16 as shown in FIGS. 1A-1B. Any of these embodiments may employ a hollow shaft instead of a solid shaft. The tear drop stirring head 36 may have a smaller surface area than that of a teaspoon and be suitable for stirring and mixing liquid with low viscosity and/or low solid content while the auger stirring head 16 is better for stirring and mixing high viscosity food and/or high solid content. Stirring devices 30, 40 and 50 have the tapered necks 33, 43 and 53 and the locking jigs 32, 42 and 52 described in connection with FIGS. 1A and 2A.

FIG. 4 illustrates the mixing and stirring device 10 attached to a kitchen appliance electric mixer 60. It can be used to stir a food 62 with high solid content 63 such as natural peanut butter. The locking jig 12 of the tapered neck 13 (FIG. 1A) locks snugly into the receptacle of kitchen appliance electric mixer 60. The user holds the jar 64 with one hand and inserts the mixing and stirring device 10 into the food 62. The auger stirring head 16 with shaft 14 rotate in direction 70 when power is applied through the kitchen appliance electric mixer 60. The auger stirring head 16 cuts, crushes, and/or breaks up the solid contents 63, generates an uplifting movement 69 that stirs and mixes the food 62 without a producing a vortex that cause spills or splashes. The user can move the kitchen appliance electric mixer 60 in a back and forth movement 66, 68, relative to the jar 64 to increase the effectiveness in mixing and stirring device 10.

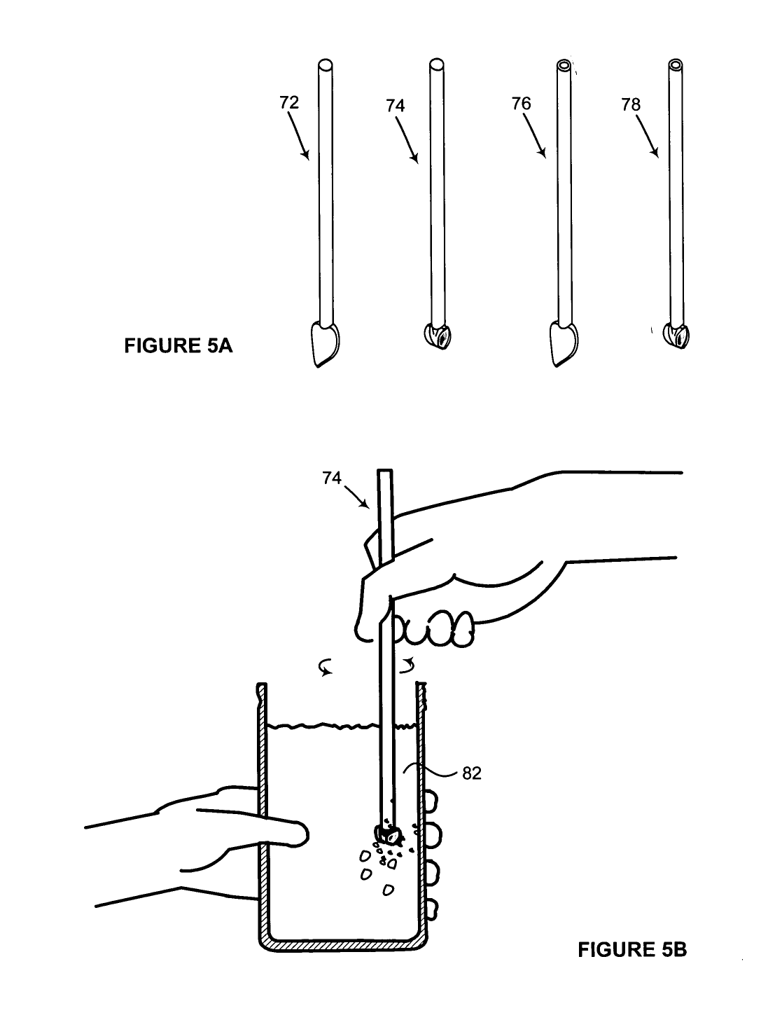

FIG. 5A illustrates hand mixing and stirring devices that have a variety of stirring heads and shafts. The hand mixing and stirring devices 72, 74, 76 and 78 can be made of solid or metal tubing, polypropylene, plastic, vinyl, or wood. The hand mixing and stirring devices 72, 74, 76 and 78 can be used to stir beverages, yogurt and honey and break up soft solid foods into a slurry. The hand mixing and stirring devices 72, 74, 76 and 78 are disposable or can be reused after washing. FIG. 5B illustrates a hand mixing and stirring device 74 for stirring food 82.

1. A mixing and stirring device for attachment to a kitchen appliance electric mixer, comprising:
a shaft with a locking jig at a first end, wherein the locking jig fits into a receptacle of the kitchen appliance electric mixer, with an auger stirring head at a second end, wherein the auger stirring head is substantially cylindrical shaped and extends laterally from the shaft, and wherein the auger stirring head includes twisted concave surfaces on anti-parallel surfaces forming a set of blade edges.

2. The device of claim 1, wherein the angular rotation of the twisted concave surfaces is about 20 degrees from the axis of the shaft.

3. The device of claim 1, wherein the shaft has a triangular, rectangular, or circular cross-section.

4. The device of claim 3, wherein the shaft is solid or hollow.

5. The device of claim 1, wherein the kitchen appliance electric mixer rotates the mixing and stirring device in food and wherein the twisted concave surfaces generate an uplifting stirring movement and the blade edges cut any solids.

6. A mixing and stirring device for a kitchen appliance electric mixer, comprising:
a shaft with a locking jig at a first end and a tear drop stirring head at a second end, wherein the locking jig fits into a receptacle of the kitchen appliance electric mixer, wherein the tear drop stirring head rotates when driven by the kitchen appliance electric mixer, and wherein the tear drop stirring head stirs, cuts, crushes, and/or breaks up any solid food content.

7. The device of claim 6, wherein the shaft has a triangular, rectangular, or circular cross-section.

8. The device of claim 6, wherein the surface area of the tear drop stirring head is less than the surface area of a teaspoon to avoid a vortex when the mixing and stirring device is rotated in a high viscosity fluid.

9. The device of claim 7, wherein the shaft is solid or hollow.

10. A hand mixing and stirring device, comprising:
a shaft with an auger stirring head, wherein the auger stirring head is substantially cylindrical shaped and extends laterally from the shaft, wherein the auger stirring head includes twisted concave surfaces on anti-parallel surfaces forming a set of blade edges.

11. The device of claim 10, wherein the shaft is solid or hollow.

12. The device of claim 10, wherein the shaft has a triangular, rectangular, or circular cross-section.

13. The device of claim 10, wherein the device is made of disposable materials.
